(19) United States
(12) Patent Application Publication
(10) Pub. No.: US 2023/0036462 A1
(43) Pub. Date: Feb. 2, 2023

(54) Recreational Vehicles With Heated Steering Components

(71) Applicant: Polaris Industries Inc., Medina, MN (US)

(72) Inventors: Timothy P. Norstad, Turtle Lake, WI (US); Aidan SHAUGHNESSY, Minneapolis, MN (US)

(21) Appl. No.: 17/844,303

(22) Filed: Jun. 20, 2022

Related U.S. Application Data
(60) Provisional application No. 63/228,334, filed on Aug. 2, 2021.

(51) Int. Cl. B60R 16/027; B62D 1/06

(52) U.S. Cl. CPC B60R 16/027; B62D 1/06

(57) ABSTRACT

A system for communicating with components on a steering member has a first electrically conductive coil affixed to a stationary component around a steering shaft of the vehicle. A second electrically conductive coil is coupled to and rotating with the steering member. The second transceiver is wirelessly operatively coupled the first transceiver. The first transceiver coupled to the first electrically conductive coil. A second transceiver is coupled to the second electrically conductive coil. The first electrically conductive coil induces current in the second electrically conductive coil to power a first component of the components. The first electrically conductive coil is spaced apart from the second electrically conductive coil. The first transceiver and the second transceiver bi-directionally wirelessly communicate through the first electrically conductive coil and the second electrically conductive coil.

### INCORPORATION BY REFERENCE

This application is a non-provisional application of 63/228,334 filed Aug. 2, 2021. This application incorporates by reference herein the entire disclosures of U.S. application Ser. No. 16/734,846 filed on Jan. 6, 2020 and U.S. application Ser. No. 16/735,077 filed on Jan. 6, 2020. The entire disclosures of the above applications are incorporated herein by reference.

### FIELD

The present disclosure relates to systems and methods for controlling and heating components in a vehicle, and in particular to systems and methods for wirelessly transferring power to a steering member and communicating data between the steering member and other components.

### BACKGROUND

Vehicles may be open-air vehicles that do not include a roof and/or outer housing. As the ambient temperature surrounding the vehicle decreases, the user of the vehicle may get colder. As such, to provide additional comfort to the user, heated features may be provided. However, the heated features may include many wired connections and/or additional heated components. Similar circumstances may also be present in closed cab vehicles.

In some examples, off-road and on-road vehicles may include a steering system with one or more steering inputs, such as handlebars with handgrips or a steering wheel. The handgrips may be heated using wires and/or other circuitry connected to a controller and/or a battery. However, the wires may wear down as a user continuously rotates the handgrips to operate the two-wheeled vehicle. Eventually, the user may need to replace the wires and/or handgrips to prevent malfunction of the heated feature for the handgrips.

For a steering wheel, clock springs are typically used to provide electricity to a heated steering wheel. The clock springs limit the number of rotational turns of the steering wheel. Further, there is a limit to the amount of current that can be provided to the steering wheel through a clock spring based on the number and size of wires routed through the clock spring. Clock springs are also susceptible to fouling due to dust, dirt, mud and water intrusion.

Automotive standards provide guidelines for surface temperatures of heated components that require feedback to be communicated about the heated touch points of a vehicle so that the power can be regulated to such components.

### SUMMARY

In an exemplary example of the present disclosure, a system for communicating with components on a steering member has a first electrically conductive coil affixed to a stationary component around a steering shaft of the vehicle. A second electrically conductive coil is coupled to and rotating with the steering member. The second transceiver is wirelessly operatively coupled the first transceiver. The first transceiver coupled to the first electrically conductive coil. A second transceiver is coupled to the second electrically conductive coil. The first electrically conductive coil induces current in the second electrically conductive coil to power a first component of the components. The first electrically conductive coil is spaced apart from the second electrically conductive coil. In addition, the system may have he first transceiver and the second transceiver bi-directionally wirelessly communicating through the first electrically conductive coil and the second electrically conductive coil.

Implementations may include one or more of the following features. The system where the first electrically conductive coil is overmolded and where the second electrically conductive coil is overmolded. The first electrically conductive coil is overmolded to a stationary coil holder and where the second electrically conductive coil is overmolded to a rotating coil holder. The system may include a housing disposed around the steering shaft, said stationary coil holder coupled to the housing. The first electrically conductive coil is affixed to a steering housing and disposed in an axial direction and coaxial with a longitudinal axis of the steering member, and where the second electrically conductive coil is radially spaced apart from and coaxial with the first electrically conductive coil and the steering housing. The system may include a dielectric layer disposed radially between the steering housing and the first electrically conductive coil. The first electrically conductive coil and the second electrically conductive coil are cylindrical. The first component may include a steering member heating element. The steering member may include a thermal sensor generating a temperature signal, where the second transceiver communicates the temperature signal to a vehicle controller through the second transceiver and the second electrically conductive coil and the first transceiver and the second electrically conductive coil. The vehicle controller communicates a heating element control signal to the first transceiver and the first electrically conductive coil, said second transceiver receiving the heating element control signal and the heating element control signal controlling the steering member heating element. The vehicle controller communicates a heating element control signal to the first transceiver and the first electrically conductive coil, said second transceiver receiving the heating element control signal and communicating the heating element control signal to a steering member controller to control the steering member heating element. The steering member may include a button generating a button signal and where the button signal is communicated from the second transceiver to the first transceiver through the second electrically conductive coil and the first electrically conductive coil. The first transceiver communicates serial signals to the second transceiver. The steering member may include an indicator and may include a steering member controller controlling the indicator using an indicator signal communicated from the first transceiver to the second transceiver. The steering member may include a display, may include a steering member controller controlling the display using a display signal communicated from the first transceiver to the second transceiver. The system said first transceiver and said second transceiver bi-directionally wirelessly communicating through the first electrically conductive coil and the second electrically conductive coil. Implementations of the described techniques may include hardware, a method or process, or computer software on a computer-accessible medium.

One general aspect includes a method for communicating with components on a steering member. The method also includes controlling a first electrically conductive coil disposed around a steering shaft. The method also includes inducing, in response to controlling, current in a second electrically conductive coil coupled to the steering member to power a first component, said first electrically conductive coil spaced apart from the second electrically conductive coil. The method also includes bi-directionally wirelessly communicating signals between a first transceiver coupled to the first electrically conductive coil and a second transceiver coupled to the second electrically conductive coil. Other embodiments of this aspect include corresponding computer systems, apparatus, and computer programs recorded on one or more computer storage devices, each configured to perform the actions of the methods.

Implementations may include one or more of the following features. The method where bi-directionally wirelessly communicating signals may include communicating a thermal sensor signal from the second transceiver to the first transceiver and communicating a steering member heating element control signal from the first transceiver to the second transceiver. Bi-directionally wirelessly communicating signals may include communicating a user interface signal from the second transceiver to the first transceiver and communicating a control signal from the first transceiver to the second transceiver. Bi-directionally wirelessly communicating signals may include communicating a transmission shift signal, a vehicle mode signal or a music control signal from a user interface from the second transceiver to the first transceiver, controlling a transmission shift in response to the transmission shift signal, a vehicle mode signal or a music control signal and communicating a status signal from the first transceiver to the second transceiver. Bi-directionally wirelessly communicating signals may include communicating a thermal sensor signal from the second transceiver to the first transceiver, generating a current control signal in response to the thermal sensor signal and communicating the current control signal from the first transceiver to the second transceiver. Implementations of the described techniques may include hardware, a method or process, or computer software on a computer-accessible medium.

One general aspect includes a method for operating a steering assembly of a vehicle having a steering member. The method also includes receiving, by a controller, a user input signal indicating a temperature setting; determining, based on the temperature setting, an amount of current to provide to a first electrically conductive coil, where the first electrically conductive coil is coupled around a steering shaft; and providing, based on the amount of current and by the controller, a current to the first electrically conductive coil, where the first electrically conductive coil is configured to wirelessly provide power to a second electrically conductive coil, and where the second electrically conductive coil is configured to provide the power to a heating element. Other embodiments of this aspect include corresponding computer systems, apparatus, and computer programs recorded on one or more computer storage devices, each configured to perform the actions of the methods.

Implementations may include one or more of the following features. The method where the first electrically conductive coil is configured to wirelessly provide the power to the second electrically conductive coil based inducing a second current. Implementations of the described techniques may include hardware, a method or process, or computer software on a computer-accessible medium.

Additional features of the present disclosure will become apparent to those skilled in the art upon consideration of the following detailed description of illustrative examples exemplifying the best mode of carrying out the disclosure as presently perceived.

### BRIEF DESCRIPTION OF THE DRAWINGS

The foregoing aspects and many additional features of the present system and method will become more readily appreciated and become better understood by reference to the following detailed description when taken in conjunction with the accompanying drawings, where:

FIG. 1 is a block diagrammatic view of a portion of a vehicle according to the present disclosure.

FIG. 2A is a plan view of a zoned steering member.

FIG. 2B is a plan view of a fully heated steering member.

FIG. 3A is a side view of a steering assembly.

FIG. 3B is a cross-sectional view of a steering assembly.

FIG. 3C is a perspective view of the stationary coil holder and the rotating coil holder.

FIG. 3D is a perspective view of the stationary coil holder.

FIG. 3E is a perspective view of the rotating coil holder.

FIG. 4 is a front view of a steering member.

FIG. 5 is a schematic of a control circuit for a steering member.

FIG. 6 is a block diagrammatic view of four options for a steering member heating system.

FIG. 7 is a flowchart of a method for shifting from the steering member.

FIG. 8 is a screen display for a shifting system.

FIG. 9 is a flowchart of a method for reflashing the buttons in a steering member.

FIG. 10 is a flowchart of a method for communicating a button feedback signal from a steering member.

FIG. 11 is a flowchart of a method for controlling a display or performing an action at a steering member.

FIG. 12 is a perspective view of a coaxial spring assembly.

FIG. 13 is a cross-sectional view of the spring assembly of FIG. 12.

### DETAILED DESCRIPTION

For the purposes of promoting an understanding of the principles of the present disclosure, reference will now be made to the examples illustrated in the drawings, which are described below. The examples disclosed below are not intended to be exhaustive or limited to the precise form disclosed in the following detailed description. Rather, the examples are chosen and described so that others skilled in the art may utilize their teachings.

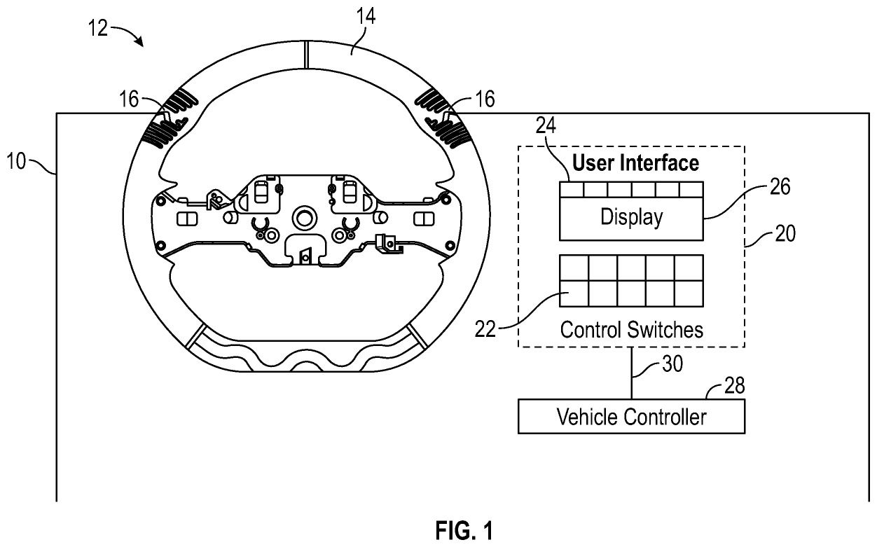

Referring now to FIG. 1, a recreational vehicle 10, such as a four wheeled side-by-side vehicle, is illustrated. However, in examples, the vehicle 10 may be any vehicle, such as a two-wheel vehicle, a three-wheel vehicle, and/or other types of recreational vehicles that may used on roads, trails, and/or both. Some examples of the recreational vehicle 10 includes, but are not limited to, motorcycles, all-terrain vehicles (ATVs), side-by-side recreational vehicles, snowmobiles, and utility vehicles.

The recreational vehicle 10 further includes a steering system 12. The steering system 138 is coupled to at least one ground engagement members, such as a wheel, ski or track, not shown. The steering system 12 has a steering member 14 adapted to be grasped by a user of the vehicle 10. The illustrative steering members 14 include handlebars and/or steering wheels. A steering member 14 is illustrated as a steering wheel in the following examples. Additionally, and/or alternatively, the steering member 14 includes one or more user grips 16. An illustrative user grip 16 is a handgrip such as a motorcycle handgrip or a pliable portion disposed on or around the steering wheel.

A user interface 20 is illustrated. The user interface 20 may include a plurality of control switches 22 and/or a plurality of touch screen buttons 24 displayed on a display 26. A knob 27 may also be used for providing input to the system. The knob 27 may control a vehicle function and/or the display 26. The user interface 20 is used to input a desired user function which is converted to a user interface signal that may ultimately be communicated to a vehicle controller 28 through a controller area network 30. The vehicle controller 28 may control a particular function based upon the input of the user interface signal or signals. Examples of suitable user interface signals include but are not limited to a signal controlling a radio (a music control signal), a vehicle mode control signal controlling a vehicle ride function such as suspension or steering, a signal controlling the heating and/or cooling of various components including the steering member 14, a signal controlling the transmission of the vehicle, and a control system signal controlling the client control system of the vehicle including heating or cooling the seats of the vehicle. Of course, numerous other vehicle functions and the corresponding signals would be evident to those skilled in the art.

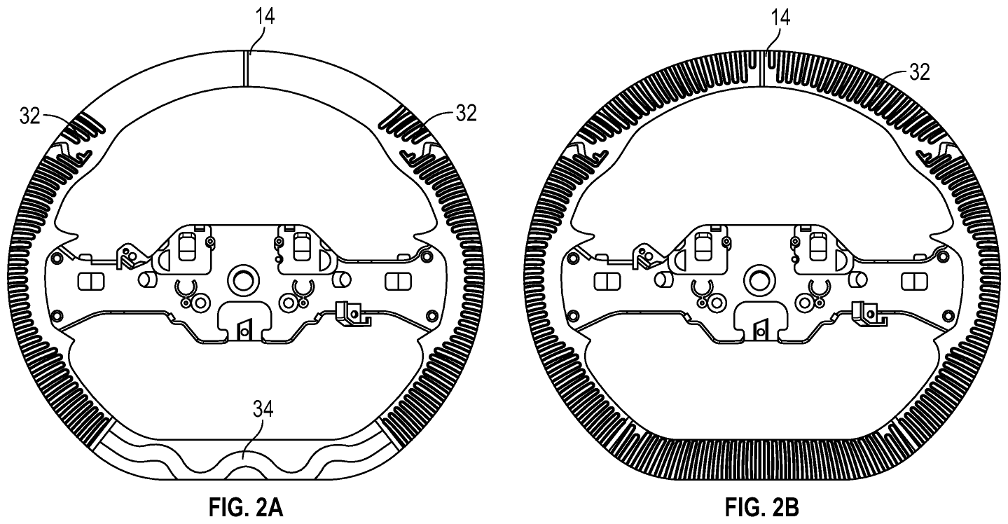

Referring now to FIG. 2A, the steering member 14 illustrated as a steering wheel is set forth. In this example, the steering member 14 may include heating elements 32 extending partially around the circumference of the steering wheel. In this example, the right side and left side of the steering member includes heating elements 32. The heating elements 32 may be joined by a joining element 34 that extends electrically therebetween. Each of the heating elements 32 each are around one third of the circumference of the steering member 14.

Referring now to FIG. 2B, a fully heated steering member 14 is illustrated having the heating element 32 extending around the circumference thereof. Of course, the amount or the spacing of the wires of the heating elements may determine the amount of heat provided to the user. For example, a wider spacing of the heating elements 32 may provide less heat than close together heating elements. Although the heating elements 32 are illustrated, a covering disposed over the heating elements to provide a smooth finish surface is used. The heat from the heating elements 32 travels through the cover.

The amount of or spacing of the heating coils may vary depending on the desired design goals. Reducing the heated area as in FIG. 2A to increase the W/cm² may be a goal. This enables higher heat targets and enabling reaching the desired targets quicker than if there is a larger area to heat.

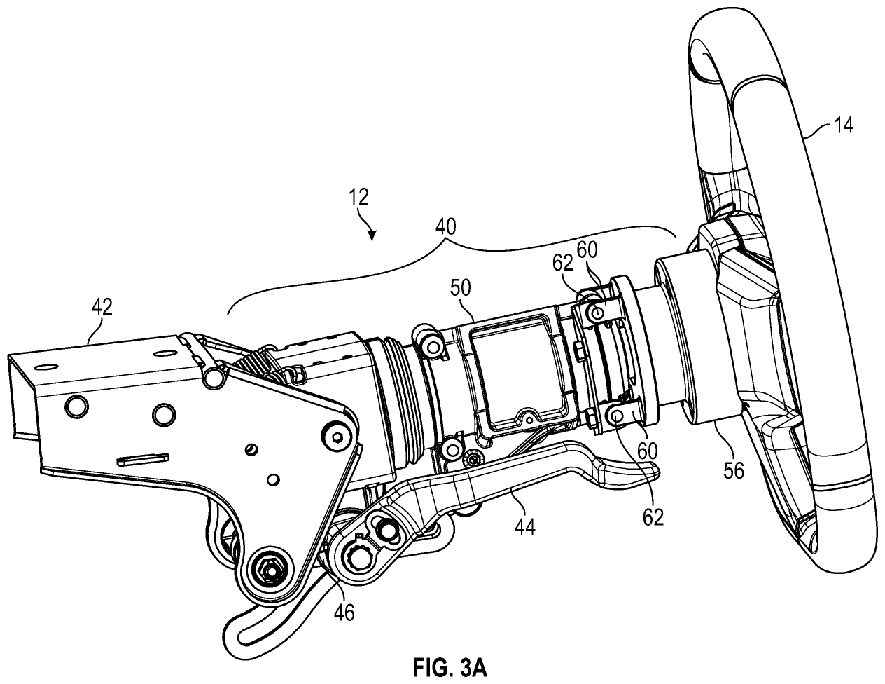

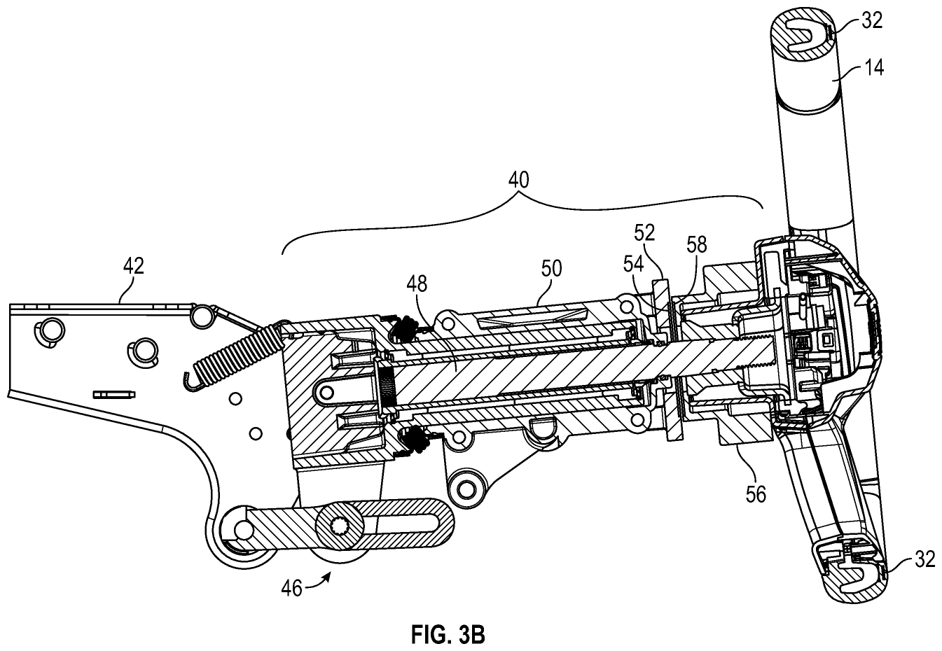

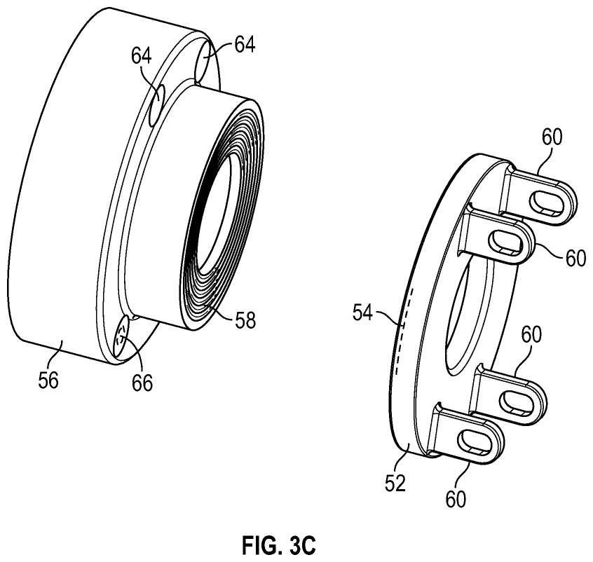

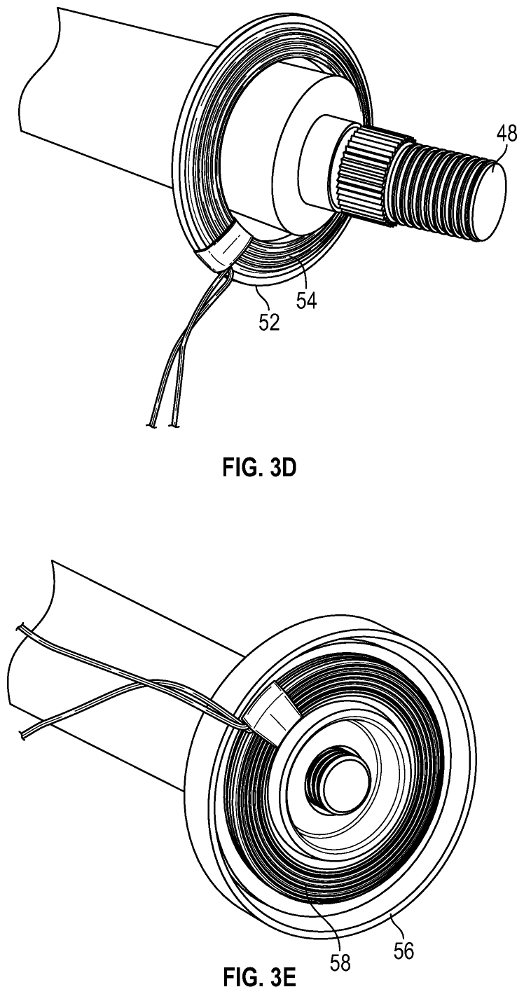

Referring now to FIGS. 3A-3F, the steering system 12 is illustrated in further detail. The steering system 12 has a steering column 40 that is coupled to the vehicle with a bracket 42. In this example, the steering column 40 can rotate relative to the vehicle at the bracket 42. To lock the steering column 40 in place, a handle 44 together with a steering mechanism 46 is used. The steering column 40 has a steering shaft 48 that is rotatably coupled relative to a housing 50. That is, the steering shaft 48 rotates within the housing 50. The steering shaft 48 is coupled to the steering member 14. As the steering member 14 is turned by the vehicle operator, the steering shaft 48 moves within the housing 50 in the same direction as the steering member 14. Ultimately, the ground engagement members of the vehicle are turned when the steering member 14 and the steering shaft 48 are turned.

The housing 50 is stationary during operation. The housing 50 is one example of a stationary component. A stationary coil holder 52 is another stationary component and has a first electrically conductive coil 54 coupled thereto. The first electrically conductive coil 54 may be affixed to the stationary coil holder 52 in a variety of ways including adhesive. However, the stationary coil holder 52 may be overmolded into the stationary coil holder 52. A rotating coil holder 56 is incorporated at, on or near the steering member 14. The rotating coil holder 56 may be a separate component or part of the molded steering member. The rotating coil holder 56 has a second electrically conductive coil coupled thereto. The coil 58 is fixed to the rotating coil holder 56 in a similar manner to the first electrically conductive coil. That is, the adhesive or overmolding described above may be used for affixing the second electrically conductive coil to the rotating coil holder 56. The first electrically conductive coil 54 and the second electrically conductive coil 58 are spaced apart from each other by a small gap that is small enough to allow the coils to be inductively coupled together.

A mount 60, of which four are illustrated in this example, extends from the stationary coil holder 52 to receive fasteners 62 for coupling the stationary coil holder 52 to the housing 50. The mount 60 may also be press fit into place rather than using fasteners 62.

Fastener receivers 64 are disposed through the rotating coil holder 56 and are used to receive fasteners 66, one of which is shown. The fasteners 66 secure the rotating coil holder 56 to the steering wheel assembly or steering member 14.

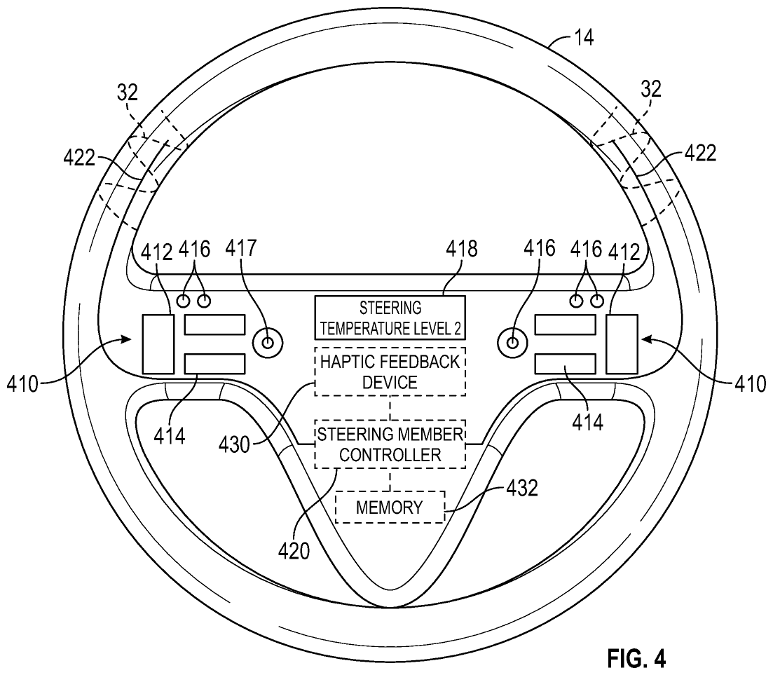

Referring now to FIG. 4, the steering member 14 is illustrated in further detail. The steering member 14 may have one or all of the components set forth in the present example. In this example, a steering member user interface 410 is illustrated having a plurality of switches 412 and buttons 414. The switches or buttons may also be implemented in a knob 417. The knob 417 may be redundant to the knob 27 set forth above or may control vehicle features or the display 26 or a display 418 independently. Indicators 416 may also be incorporated into the steering member 14. The display 418 is included within the steering member 14. The display 418, for example, may be an LCD display that displays color or black or white text and images. The switches 412, the buttons 414 and knob 417 may be used for providing or controlling various vehicle functions. The status of the vehicle functions may be displayed at the indicators 416 and/or the display 418. For example, the switches 412 and buttons 414 may be used to generate heating element control signals directly or indirectly through a controller to control the heating elements 32 disposed within the steering member 14. The indicators 416 may be LED lights or other types of indicators. The indicators 416 may have a variety of colors to indicate different states of various components.

A steering member controller 420 receives switch signals (control signals) from the switches 412 and button signals from the buttons 414. The steering member controller 420 may control or communicate with other portions of the vehicle through the first electrically conductive coil and the second electrically conductive coil as will be described in further detail below. The steering member controller 420 may also be coupled to a thermal sensor 422. The thermal sensor 422 may sense the heat being provided by the heating elements and generate a temperature signal corresponding to the temperature of the heating elements 32 within the steering member 14. The thermal sensor 422 may include but is not limited to a thermocouple or a thermistor. The indicators 416 may be LED lights or other types of indicators. The indicators 416 may have a variety of colors to indicate different states of various components.

A haptic feedback device 430 may also be provided within the steering member 14. The haptic feedback device may vibrate to provide a warning due to a sensed condition.

A memory 432 is also associated with the steering member controller 420. The memory 432 may be used for storing various commands being input and output to the system as a buffer. Memory 432 may also store button, knob or switch functions. That is, the function of the button, knobs or switches may be changed in some examples according to the user. The memory 432 may thus be reflashable as will be described in further detail below.

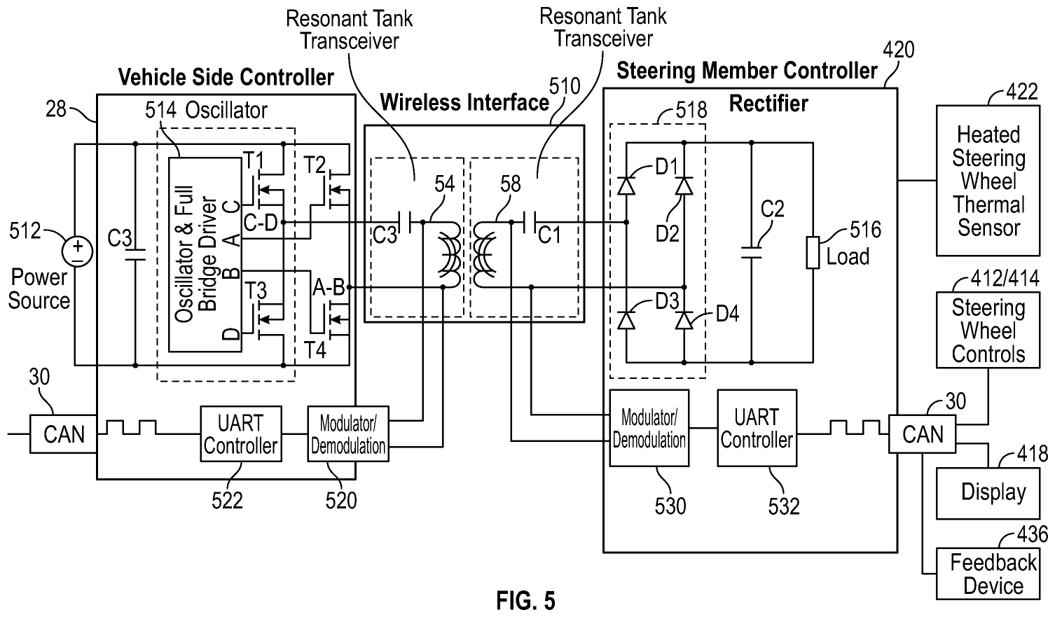

Referring now to FIG. 5, the electrical configuration of the steering system 12 is set forth. In this example, the vehicle side controller 28 is illustrated in communication with a wireless interface 510. The wireless interface 510 includes the first electrically conductive coil 54 and the second electrically conductive coil 58. The second electrically conductive coil 58 is in communication with the steering member controller 420. The vehicle side control 28 is coupled to a vehicle power source 512. The power source 512 is in communication an oscillator and full bridge driver 514 that is used to drive the wireless interface. In particular, the first electrically conductive coil 54 is used to magnetically induce electrical current in the second electrically conductive coil 58. This is used to drive a load 415 through a rectifier circuit 518 that rectifies the signal and provides DC power to the load 516. The rectifier 518 is optional and may take many forms depending on whether regulated AC power is required. In this example, the rectifier has four diodes D1, D2, D3 and D4. Diode D1 is coupled to the second electrically conductive coil 58 at the anode thereof. The cathode of diode D3 is coupled to the anode of diode D1 and the second electrically conductive coil 58. The second end of the electrically conductive coil 58 is coupled to the cathode of the diode D4 and the anode of diode D2. The cathode of diode D1 and the cathode of diode D2 are coupled to the load 516. The anode of diodes D3 and D4 are coupled to the other side of the load. A capacitor C1 is coupled to the anode of diode D1 and the cathode of diode D3. Likewise, the capacitor C2 may be coupled and parallel with the load 516.

The oscillator circuit and full bridge driver circuit 514 may be coupled to four MOSFET transistors. The transistors are used to drive the first electrically conductive coil through a capacitor C3. In this example, four MOSFETs T1, T2, T3, and T4 are provided. In this example, the gate of transistors T1 and T3 are coupled to the oscillator and full bridge rectifier driver 514. Likewise, the gates of transistors T1 and T4 are coupled to the oscillator and full bridge driver 514. The drains of transistors T1 and T2 are coupled to the power source 512. The source of transistors T3 and T4 are coupled to the negative side of the power source 512. The source of transistor T1 is coupled to the drain of transistor T3. The source of transistor T2 is coupled to the drain of transistor T4. The node between transistor T1 and T3 is coupled to a first side of the first electrically conductive coil 54. The node between the source of transistor T2 and the drain of transistor T4 is coupled to the other side of the first electrically conductive coil T4. As mentioned above, bi-directional communication may also be possible through the first electrically conductive coil 54 and the second electrically conductive coil 58. The vehicle side controller 28 includes a demodulator/modulator 520 that is in communication with a universal asynchronous receiver transmitter controller (UART) 522. The UART controller 522 receives and transmits signals to the controller area network 30. The first electrically conductive coil 54 is used for both receiving and transmitting signals. A modulator/demodulator 530 couples or communicates with the modulator/demodulator 520 through the first electrically conductive coil 54 and the second electrically conductive coil 58. The modulator/demodulators 520/530 may be formed as an integral integrated circuit or as separated components. In particular, the modulator/demodulator 530 communicates with a UART controller 532 and ultimately is in communication through a controller area network 30 with the components within the steering member 14. As mentioned above, the steering member 14 may include a display 418, a feedback device 436, steering member controls 412/514 and heated steering member thermal sensor 422.

In operation, the controller area networks 30 receive signals from switches, buttons or other components and communicate the modulator/demodulator 530 and the modulator/demodulator 520. An asynchronous serial signal is generated at the controllers 522 and 532. The modulator/demodulator 520 communicates the serial signal through the first electrically conductive coil 54 and the second electrically conductive coil 58 to the modulator/demodulator 530 and vice versa. Ultimately, different displays or controls are provided either at the vehicle side or the steering member side. One suitable example of modulator/demodulator 520/530 are the Renesas P9221-R3 and the P9242-R3.

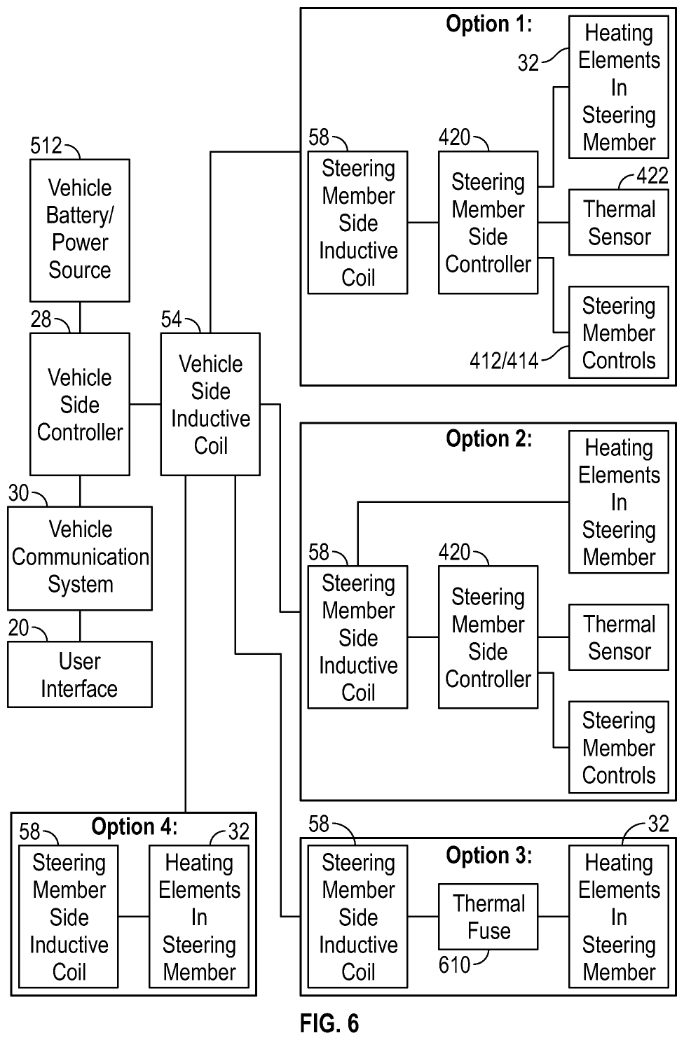

Referring now to FIG. 6, a simplified view of the control system for a heated steering element in particular is set forth. In this example, the power source 512 and the vehicle communication system such as the controller area network 30 are set forth and coupled to the vehicle side controller 228. The vehicle side inductive coil 54 is coupled to the steering member side inductive coil 58. The vehicle side controller 28 may determine an amount of current (current control signal) to be provided to the steering member side inductive coil 58 to heat the steering member heating elements. The amount of current may be determined from a temperature setting selected using the user interface. A button, knob or switch in the vehicle may be used to generate a heating element control signal. A steering member controller 420 is in communication with the steering member side inductive coil. In this example, four options are provided for the steering member heating system. In option 1, the heating elements 32, the thermal sensor 422 and steering member controls (buttons) 414 are all in communication with the steering member controller 420. The thermal sensor 422 may communicate the thermal sensor signal (temperature signal) all the way to the vehicle side controller for monitoring within the vehicle. All of the elements 32, 422 and 412/414 are in communication with the steering member controller 420.

In option 2, the same elements are provided as in option 1 except that the heating elements 32 in the steering member 14 are communicated directly to the steering member side inductive coil 58 rather than to the steering member controller 420.

In option 3, the steering member side inductive coil 58 is coupled to a thermal switch or thermal fuse 610. The thermal switch or thermostatic fuse 610 prevents the heating elements in the steering member 14 to be prevented from overheating. The thermal fuse 610 allows a maximum temperature at the steering member 14.

In option 4, the heating elements 32 are provided directly coupled to the steering member side inductive coil 58. In this example, the steering member controller 420 has been eliminated. In option 3, the steering member controller 420 is also eliminated. Options 3 and 4 are simplified versions that may or may not use bi-directional communication through the vehicle side inductive coil 54 and the steering member side inductive coil 58.

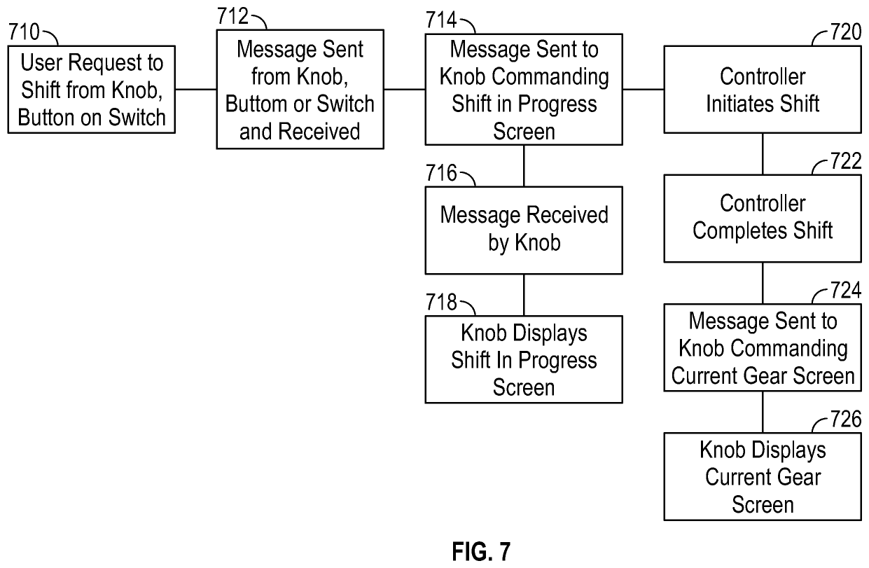

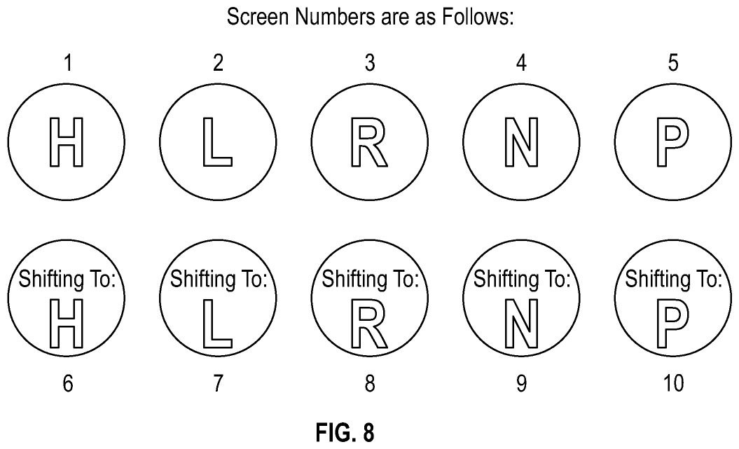

Referring now to FIGS. 7 and 8, by way of example, the system may be used for controlling a shifting of a transmission. The transmission selector may be one of the buttons or switches disposed on the steering member. In step 710, the user requests a shift from a knob, button or switch disposed on the steering member. In step 712, a transmission shift signal (message) is generated from the knob, button or switch. The knob, button or switch is illustrated in detail in FIG. 8. The knob, button or switch may include various high, low, reverse, neutral and park positions that are illuminated during the commanding process. The knob, button or switch may also be part of the display 418. In step 714, the transmission shift signal is sent to the knob commanding a shift in progress screen to be displayed at the vehicle. However, the transmission shift signal may also be received at the knob 716 to display a shift in progress screen at 718. The transmission shift signal is communicated from the second transceiver and the second electrically conductive coil wirelessly to the first electrically conductive coil and the first transceiver. In step 720, the vehicle controller 28 receives the transmission shift signal and initiates a shift of the transmission. This may be performed directly through a separate transmission controller. In step 722, the controller completes the shift. A status signal or status message is sent to the knob in step 724 in which the current gear is displayed on a display. The status message may be communicated through the first electrically conductive coil and the first transceiver to the second electrically conductive coil and the second transceiver of the steering member. The knob shift button, switch or another display displays the current gear selection in step 726. Bi-directional communication is used in the communication from the knob, button or switch to the vehicle controller and back to the knob button or switch when a status is received.

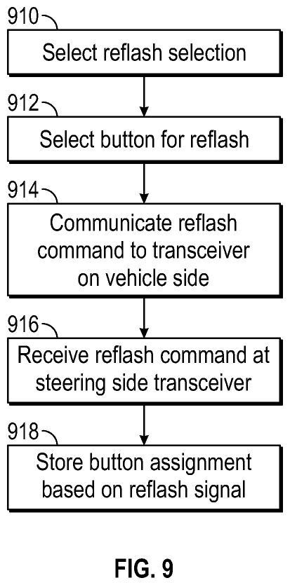

Referring now to FIG. 9, the function of the button knobs or switches may also be capable of being reflashed. That is, the memory 432 may be changed according to a different function to suit the needs of the vehicle operator. In step 910, a reflash selection is generated. The reflash selection may be communicated as a reflash selection signal to one of the vehicle controllers. In step 912, the button for reflash is selected using a vehicle interface and a controller of the vehicle. In step 914, a reflash signal command is communicated to a transceiver on the vehicle side. In step 916, a reflash command is received at the steering side transceiver. In step 918, the button knob or switch assignment is stored within a memory 432 associated with the steering member controller. The process may be initiated and processed through the control of the steering member controller 420 or the vehicle controller 28.

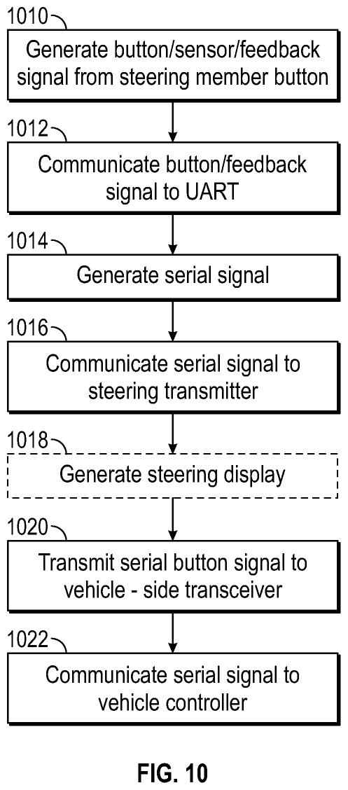

Referring now to FIG. 10, a method for communicating a serial signal to a vehicle controller is set forth. In step 1010, a button, sensor or feedback signal is communicated from a steering member button or other device located on a steering wheel or steering member. The sensor, for example, may be a pressure sensor, accelerometer, audio microphone, or temperature input. The button, sensor or feedback signal is communicated to a universal asynchronous receiver transmitter in step 1012. In step 1014, a serial signal is generated at the universal asynchronous receiver transmitter. The serial signal is communicated to a steering side transmitter in step 1016. The signal may also be displayed at a steering display in step 1018. This is an optional step. In step 1020, the transmit serial button signal is communicated to the vehicle side transceiver. This is an inductive coupling as mentioned above. In step 1022, the serial signal is ultimately communicated to one of the vehicle controllers.

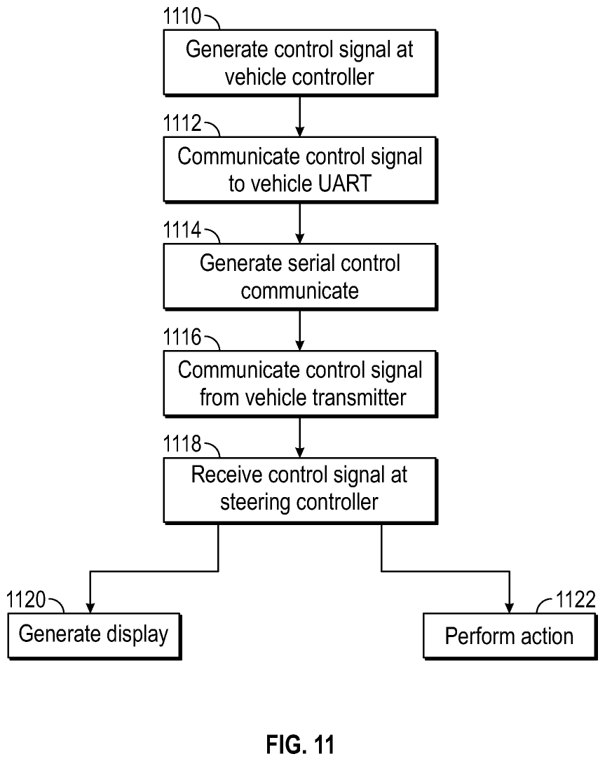

Referring now to FIG. 11, step 1110 generates a control signal at the vehicle controller 28. This may be performed in response to the serial signal at the vehicle controller. In step 1112, a control signal is communicated to the vehicle side UART. The UART generates a serial control signal in step 1114. In step 1116, the control signal is communicated from the vehicle transmitter that is received in step 1118 at the steering member controller 420. In step 1120, a display may be generated at the steering system. In step 1122, an action may be performed such as turning on or off the heating system of the steering wheel.

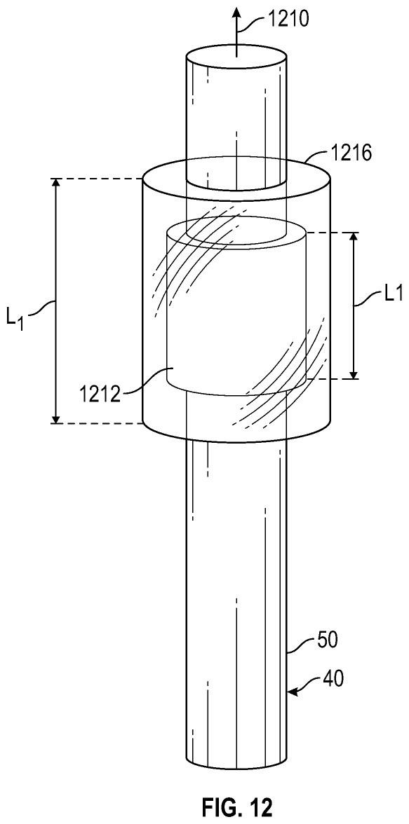

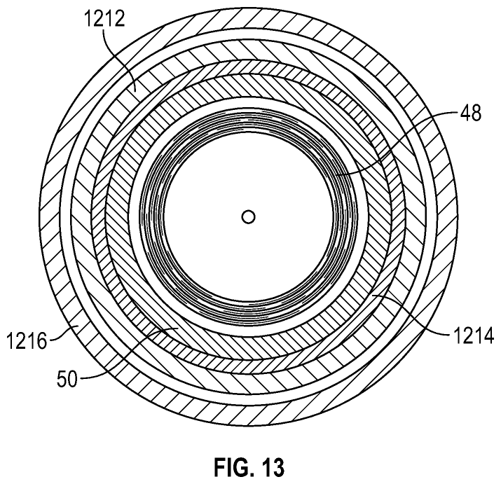

Referring now to FIGS. 12 and 13, a portion of the steering column 40 is illustrated. The steering column 40, as mentioned above, has the housing 50 disposed therearound. The steering shaft 48 is disposed within the housing and rotates inside the stationary housing 50. The steering column 40 and the housing 50 have a longitudinal axis 1210. A first electrically conductive coil 1212 is disposed around the housing 50 and extends an axial direction L₁. The first electrically conductive coil 1212 is cylindrical in shape, the length of which is L₁. By spreading the first coil in the axial direction, the entire coil assembly is easier to package because it is smaller in the radial direction.

A dielectric layer 1214 may be disposed between the first electrically conductive coil 1212 and the housing 50. The dielectric layer 1214 may be non-electrically conductive but thermally conductive to allow heat from the first electrically conductive coil 1212 to dissipate using the housing 50 as a heat sink. The dielectric layer 1214 may be formed of other graphite or other thermally conductive materials that allow the flux to be absorbed into the coil 1212 and not into the housing 50 while allowing heat transfer therethrough. The dielectric layer 1214 acts to direct magnetic flux to the other coil 1216 and to not be absorbed in the steering wheel while allowing the heat from the first electrically conductive coil 1212 to be absorbed into the steering column 40.

A second electrically conductive coil 1216 is radially spaced apart from and coaxial with the first electrically conductive coil 1212. In the present example, the second electrically conductive coil 1216 is also cylindrical and extends a distance L2 in the longitudinal direction. Again, the radial thickness of the second electrically conductive coil 1216 is reduced while the windings of the coil 1216 are extended in the axial direction.

As mentioned above, the combination of the two thin layers of coils 1212 and 1216 allow easier packaging for the coil assembly. More particularly, by stacking the first electrically conductive coil, which is cylindrical, with the second electrically conductive coil, which is also cylindrical, the radial depth from the steering housing is reduced compared to the previously illustrated examples. Further, by using cylindrical coils, heat rejection from the coils is reduced because the heat from the cylindrical coils Is distributed over a greater area of the steering shaft, which acts as a heat sink. The second electrically conductive coil 1216 may be wound in the steering wheel having an aluminum frame. The second electrically conductive coil uses the aluminum frame of the steering wheel as a heat sink.

Examples are provided so that this disclosure will be thorough and will fully convey the scope to those who are skilled in the art. Numerous specific details are set forth such as examples of specific components, devices, and methods, to provide a thorough understanding of examples of the present disclosure. It will be apparent to those skilled in the art that specific details need not be employed, that examples may be embodied in many different forms and that neither should be construed to limit the scope of the disclosure. In some examples, well-known processes, well-known device structures, and well-known technologies are not described in detail.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A system for communicating with components on a steering member of a vehicle comprising:
a first electrically conductive coil affixed to a stationary component around a steering shaft of the vehicle;
a second electrically conductive coil coupled to and rotating with the steering member;
a first transceiver coupled to the first electrically conductive coil;
a second transceiver coupled to the second electrically conductive coil, said second transceiver wirelessly operatively coupled the first transceiver;
said first electrically conductive coil inducing current in the second electrically conductive coil to power a first component of the components, said first electrically conductive coil spaced apart from the second electrically conductive coil; and

2. The system of claim 1 wherein the first electrically conductive coil is overmolded and wherein the second electrically conductive coil is overmolded.

3. The system of claim 1 wherein the first electrically conductive coil is overmolded to a stationary coil holder and wherein the second electrically conductive coil is overmolded to a rotating coil holder.

4. The system of claim 3 further comprising a housing disposed around the steering shaft, said stationary coil holder coupled to the housing.

5. The system of claim 1 wherein the first electrically conductive coil is affixed to a steering housing and disposed in an axial direction and coaxial with a longitudinal axis of the steering member;
and wherein the second electrically conductive coil is radially spaced apart from and coaxial with the first electrically conductive coil and the steering housing.

6. The system of claim 5 further comprising a dielectric layer disposed radially between the steering housing and the first electrically conductive coil.

7. The system of claim 1 wherein the first electrically conductive coil and the second electrically conductive coil are cylindrical.

8. The system of claim 1 said first transceiver and said second transceiver bi-directionally wirelessly communicating through the first electrically conductive coil and the second electrically conductive coil.

9. The system of claim 7 wherein the first component comprises a steering member heating element.

10. The system of claim 9 wherein the steering member comprises a thermal sensor generating a temperature signal, wherein the second transceiver communicates the temperature signal to a vehicle controller through the second transceiver and the second electrically conductive coil and the first transceiver and the second electrically conductive coil.

11. The system of claim 10 wherein the vehicle controller communicates a heating element control signal to the first transceiver and the first electrically conductive coil, said second transceiver receiving the heating element control signal and the heating element control signal controlling the steering member heating element.

12. The system of claim 10 wherein the vehicle controller communicates a heating element control signal to the first transceiver and the first electrically conductive coil, said second transceiver receiving the heating element control signal and communicating the heating element control signal to a steering member controller to control the steering member heating element.

13. The system of claim 7 wherein the steering member comprises a button generating a button signal and wherein the button signal is communicated from the second transceiver to the first transceiver through the second electrically conductive coil and the first electrically conductive coil.

14. The system of claim 7 wherein the first transceiver communicates serial signals to the second transceiver.

15. The system of claim 7 wherein the steering member comprises an indicator, and further comprising a steering member controller controlling the indicator using an indicator signal communicated from the first transceiver to the second transceiver.

16. The system of claim 7 wherein the steering member comprises a display, further comprising a steering member controller controlling the display using a display signal communicated from the first transceiver to the second transceiver.

17. A method for communicating with components on a steering member comprising:
controlling a first electrically conductive coil disposed around a steering shaft;
inducing, in response to controlling, current in a second electrically conductive coil coupled to the steering member to power a first component, said first electrically conductive coil spaced apart from the second electrically conductive coil; and
bi-directionally wirelessly communicating signals between a first transceiver coupled to the first electrically conductive coil and a second transceiver coupled to the second electrically conductive coil.

18. The method of claim 17 wherein bi-directionally wirelessly communicating signals comprises communicating a thermal sensor signal from the second transceiver to the first transceiver and communicating a steering member heating element control signal from the first transceiver to the second transceiver.

19. The method of claim 17 wherein bi-directionally wirelessly communicating signals comprises communicating a user interface signal from the second transceiver to the first transceiver and communicating a control signal from the first transceiver to the second transceiver.

20. The method of claim 17 wherein bi-directionally wirelessly communicating signals comprises communicating a transmission shift signal, a vehicle mode signal or a music control signal from a user interface from the second transceiver to the first transceiver, controlling a transmission shift in response to the transmission shift signal, a vehicle mode signal or a music control signal and communicating a status signal from the first transceiver to the second transceiver.

21. The method of claim 17 wherein bi-directionally wirelessly communicating signals comprises communicating a thermal sensor signal from the second transceiver to the first transceiver, generating a current control signal in response to the thermal sensor signal and communicating the current control signal from the first transceiver to the second transceiver.

22. A method for operating a steering assembly of a vehicle having a steering member, comprising:
receiving, by a controller, a user input signal indicating a temperature setting;
determining, based on the temperature setting, an amount of current to provide to a first electrically conductive coil, wherein the first electrically conductive coil is coupled around a steering shaft; and
providing, based on the amount of current and by the controller, a current to the first electrically conductive coil, wherein the first electrically conductive coil is configured to wirelessly provide power to a second electrically conductive coil, and wherein the second electrically conductive coil is configured to provide the power to a heating element.

23. The method of claim 22, wherein the first electrically conductive coil is configured to wirelessly provide the power to the second electrically conductive coil based inducing a second current.

24. The method of claim 22, further comprising limiting the amount of current based on feedback from a thermal sensor disposed at the steering member.
